(19) United States
(12) Patent Application Publication
(10) Pub. No.: US 2008/0092967 A1
(43) Pub. Date: Apr. 24, 2008

(54) Control valve assembly

(76) Inventor: Dale A. Stretch, Novi, MI (US)

Correspondence Address: EATON CORPORATION;EATON CENTER, 1111 SUPERIOR AVENUE, CLEVELAND, OH, 44114, US

(21) Appl. No.: 11/582,799

(22) Filed: Oct. 18, 2006

(51) Int. Cl. F15B 13/043

(52) U.S. Cl. 137/625.64

(57) ABSTRACT

A control valve assembly includes a valve body having a valve opening, a first pressure passage, a second pressure passage, and a valve body land. A valve member is received in the valve opening for movement between an open position and a closed position. The valve member includes a first valve member land and a second valve member land. The first valve member land and the valve body land cooperate to define a first metering flow passage and a second metering flow passage. The first and second metering flow passages are configured to impart a hydrodynamic force on the valve member during fluid flow through the valve body, which biases the valve member toward the open position or the closed position.

### CROSS-REFERENCE TO RELATED APPLICATIONS

This application is a continuation-in-part (CIP) of co-pending U.S. application, filed Oct. 17, 2006, in the name of Dale A. Stretch for a “CONTROL VALVE ASSEMBLY”.

### BACKGROUND OF THE DISCLOSURE

The present invention relates to a control valve assembly for controlling hydraulic actuators, and more particularly, to a control valve assembly having a valve member that is held in an open position by a hydrodynamic force.

A camless internal combustion engine valve actuation system typically includes hydraulic valve lifters for each engine valve. The valve lifters are typically controlled by a pair of control valve assemblies-each control valve assembly having a two-position valve spool selectively moved by a pair of solenoid actuators. Fluid pressure is distributed to each control valve by a switching valve, which also includes a two-position valve spool controlled by a pair of solenoid actuators. The control valve assemblies and the switching valve are controlled by an engine controller, so that timing of the valve spool movement from one position to the other is a function of engine crankshaft position. Each engine valve is selectively opened and closed as one of the control valve spools selectively connects an engine valve actuator to a control pressure or to a low-pressure reservoir. The control valve spools for each engine valve actuator are switched between their two positions by alternately energizing and de-energizing the solenoid actuators. Designers continue to improve upon conventional control valve assembly designs to enhance the overall efficiency of the system.

### BRIEF SUMMARY OF THE INVENTION

A control valve assembly is provided that includes a valve body having a valve opening, a first pressure passage, a second pressure passage, and a valve body land. A valve member is received in the valve opening for movement between an open and a closed position. The valve member includes a first valve member land and a second valve member land. The first valve member land and the valve body land cooperate to define a first metering flow passage between the first and second pressure passages, and the valve body land and the second valve member land cooperate to define a second metering flow passage between the first and second pressure passages. The first and second metering flow passages are configured to impart a hydrodynamic force on the valve member during fluid flow through the valve body, which biases the valve member toward the open position or the closed position.

### BRIEF DESCRIPTION OF THE DRAWINGS

FIG. 1 is a schematic diagram of a hydraulically operated engine valve system using a switching valve and two control valve assemblies according to the present invention;

FIG. 2 is a cross-sectional view of a control valve assembly according to an embodiment of the present invention;

FIG. 3 is an enlarged cross-sectional view of the control valve assembly of FIG. 2, showing the flow of fluid between a valve member and a valve body;

FIG. 4A is an enlarged cross-sectional view of the control valve assembly of FIG. 2, showing the valve member in a closed position;

FIG. 4B is an enlarged cross-sectional view of the control valve assembly of FIG. 2, showing the valve member during its initial movement from the closed position;

FIG. 4C is an enlarged cross-sectional view of the control valve assembly of FIG. 2, showing the valve member between the closed and an open position;

FIG. 4D is an enlarged cross-sectional view of the control valve assembly of FIG. 2, showing the valve member in an open position; and

FIG. 5 is a plot showing the force acting on the valve member shown in FIGS. 4A-4D at various valve member displacements.

### DETAILED DESCRIPTION OF THE INVENTION

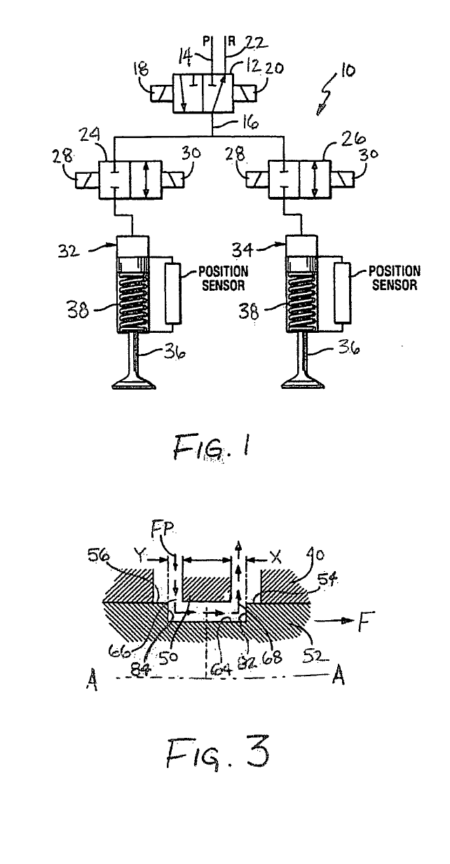

Referring now to the drawings, which are not intended to limit the invention, FIG. 1 illustrates, schematically, a hydraulically operated engine valve system 10 that includes a two-position switching valve 12. A pressure inlet port 14 provides a pressure distribution path to a control pressure passage 16 when a first solenoid 18 is energized. When a second solenoid 20 is energized and first solenoid 18 is de-energized, control pressure passage 16 is connected with a reservoir low-pressure passage 22. Passage 16 communicates with a pair of control valve assemblies 24, 26 according to the present invention. As will be described in further detail below, each control valve assembly 24, 26 includes a two-position valve member that is controlled by at least one, but more likely two solenoid actuators 28, 30. When the solenoid actuator 28 is energized, the valve member is shifted to an open position to provide passage 16 in communication with engine valve actuator 32, 34. When solenoid actuator 30 is energized and solenoid actuator 28 is de-energized, the valve member is moved to a closed position to block communication between passage 16 and an engine valve actuator 32, 34. Actuators 32, 34 open an engine valve 36 when the actuator is pressurized and a valve spring 38 closes the engine valve 36 when the actuator is depressurized.

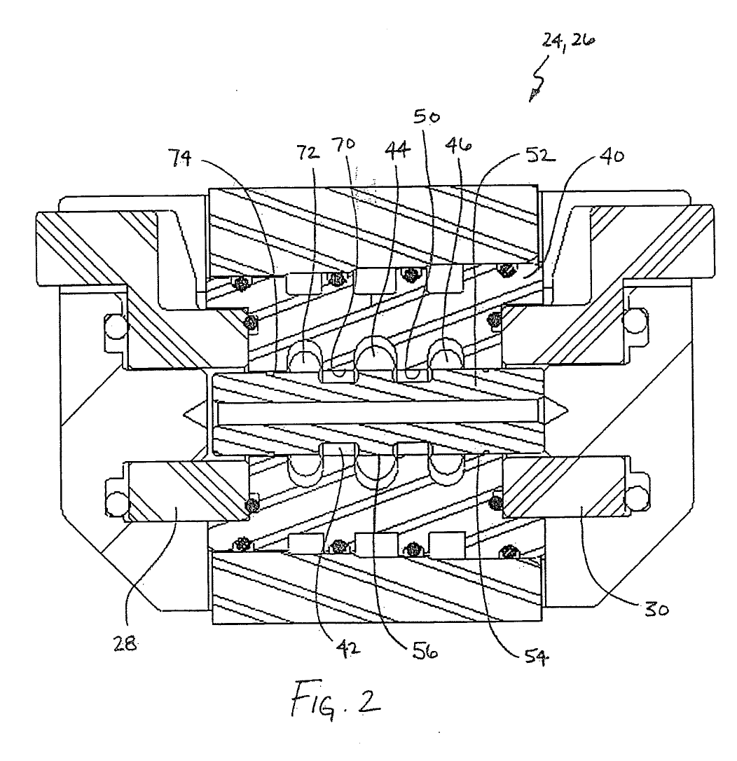

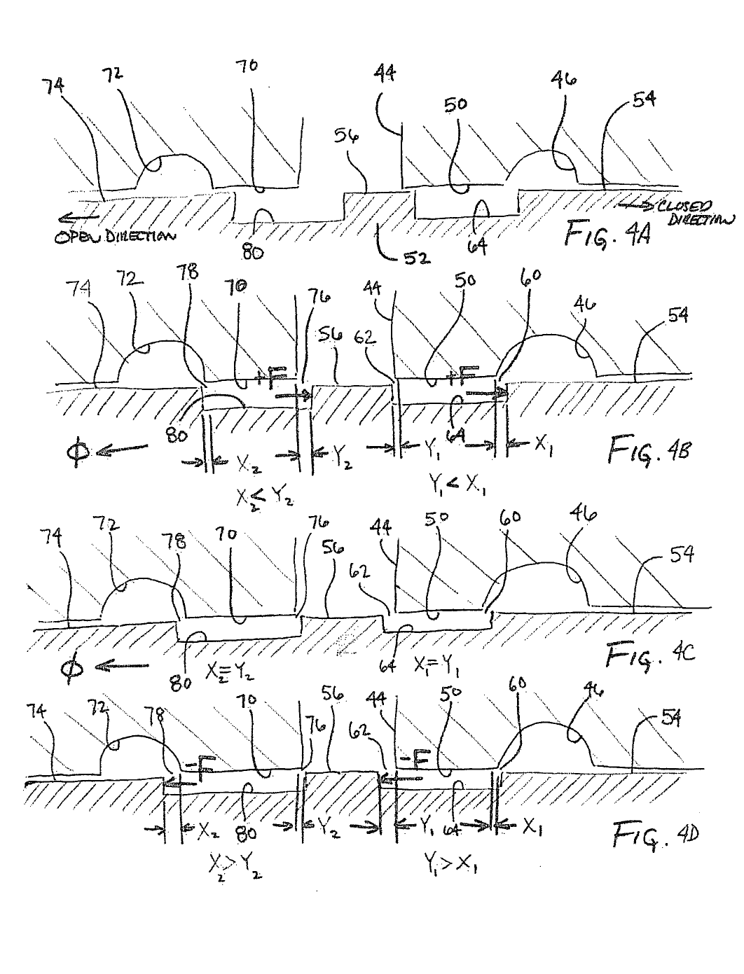

FIG. 2 is a cross-sectional view of control valve assemblies 24, 26 according to an embodiment of the present invention. In the illustrated embodiment, control valve assemblies 24, 26 include a valve body 40 having a valve opening or bore 42, a first pressure passage 44, a second pressure passage 46, and a valve body land 50. A valve member 52 is received in the valve opening 42 for movement between a closed position (see, e.g., FIG. 4A) and an open position (see, e.g., FIG. 4D). In an embodiment, the valve member 52 comprises a valve spool having known magnetic properties and the solenoids 28, 30, when energized, produce magnetic flux that imparts a magnetic force on the valve spool.

As shown in FIG. 2, the valve member 52 may include a first valve member land 54 and a second valve member land 56. As shown in detail in FIGS. 4B-4D, the first valve member land 54 and the valve body land 50 cooperate to define a first metering flow passage 60 between the first and second pressure passages 44, 46, and the valve body land 50 and the second valve member land 56 cooperate to define a second metering flow passage 62 between the first and second pressure passages 44, 46. When so configured, the valve member 52 may include an annular cavity 64 that cooperates with the valve body 40 to define a flow path (FP) between the first pressure passage 44 and the second pressure passage 46 (see, e.g., FIG. 3). The flow path (FP) includes an inlet 66 and an outlet 68-both of which help define the first and second metering flow passages 60, 62 (FIG. 4B-4C), respectively.

In the embodiment shown in FIG. 2, the valve body 40 may also include a second valve body land 70 and a third pressure passage 72, and the valve member 52 may also include a third valve member land 74. The second valve member land 56 and the second valve body land 70 cooperate to define a third metering flow passage 76 (FIG. 4B-4C) between the first and third pressure passages 44, 72, and the second valve body land 70 and the third valve member land 74 cooperate to define a fourth metering flow passage 78 between the first and third pressure passages 44, 72. When so configured, the valve member 52 may include a second annular cavity 80 (FIG. 4B-4C) that cooperates with the valve body 40 to define a second flow path between the first pressure passage 44 and the third pressure passage 72.

FIG. 3 demonstrates how hydrodynamic forces can be developed in control valve assembly 24, 26 as the valve member 52 moves relative to the valve body 40. In the illustrated embodiment, as fluid circulates through the valve assembly, the fluid flow changes direction from a path generally perpendicular to an axis (A-A) of the valve member 52 to a path generally parallel to the axis, and then back to a path generally perpendicular to the axis of the valve member. This fluid flow will create a hydrodynamic force on each end wall 82, 84 of the cavity 64 that is generally parallel to the axis of the valve member. In FIG. 3, if dimension “X” is greater than dimension “Y”, the fluid flow velocity at the inlet 66 will be greater than the fluid flow velocity at the outlet 68. Because of the Bernoulli effect, the fluid pressure acting on the end wall 82 adjacent the outlet 68 is greater than the pressure acting on the other end wall 84 adjacent the inlet 66. This results in a net hydrodynamic force (F) acting on the valve member 52 in the direction denoted by the arrow in FIG. 3.

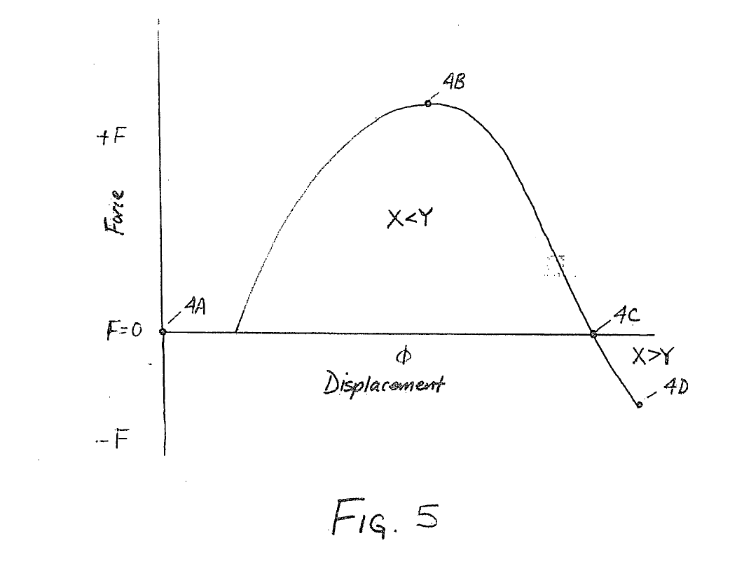

The position of the valve member 52 is shown at different stages of operation in FIGS. 4A-4D, with the relationship between the hydrodynamic force (F) applied to the valve member by the fluid flow and the valve member displacement (φ) being depicted graphically in FIG. 5. Displacement of the valve member 52 at the various positions shown in FIGS. 4A-4D is denoted by the figure number in FIG. 5.

In FIG. 4A, the valve member 52 is in its closed position with no fluid flow between first pressure passage 44 and second or third pressure passages 46, 72. Accordingly, as shown in FIG. 5, there is little or no hydrodynamic force acting on the valve member 52.

When the solenoid actuator 28 is energized, the valve member 52 is moved toward the open position-the initial movement being depicted in FIG. 4B. The dimension “X₁” in FIG. 4B is greater than the dimension “Y₁”, which, for all other dimensions being equal, results in the first metering flow passage 60 having a larger area than the second metering flow passage 62. The dimension “X₂” in FIG. 4B is less than the dimension “Y₂”, which, for all other dimensions being equal, results in the third metering flow passage 76 having a larger area than the fourth metering flow passage 78. Thus, the hydrodynamic forces (F) applied to the valve member 52 in each cavity 64, 80 opposes the force applied by solenoid 28 to move the valve member 52. As shown in FIG. 5, the net hydrodynamic force (F) increases as the fluid flow path is opened until it reaches a maximum force corresponding to the displacement shown in FIG. 4B.

As valve member 52 is further moved toward the open position, as shown in FIG. 4C, the net hydrodynamic force (F) opposing the solenoid force decreases until dimension “X₁” is generally equal to “Y₁”, and “X₂” is generally equal to “Y₂”, at which point there is no hydrodynamic force opposing the solenoid force (see Point 4C in FIG. 5).

When the valve member 52 is further moved toward the open position shown in FIG. 4D, the dimension “X₁” becomes less than the dimension “Y₁”, which, for all other dimensions being equal, results in the second metering flow passage 62 having a larger area than the first metering flow passage 60. The dimension “X₂” in FIG. 4D becomes greater than the dimension “Y₂”, which, for all other dimensions being equal, results in the fourth metering flow passage 78 having a larger area than the third metering flow passage 76. Thus, the hydrodynamic forces (F) applied to the valve member 52 in each cavity 64, 80 complements the force applied by solenoid 28 to move valve member 52. In the open position shown in FIG. 4D, the net hydrodynamic force (F) acts to hold the valve member in the open position, allowing the solenoid 28 to be deactivated without substantial movement of the valve member 52 from the open position.

The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. A control valve assembly for controlling distribution of fluid pressure to a fluid pressure actuator, the control valve assembly comprising:
a valve body having a valve opening, a first pressure passage, a second pressure passage, and a valve body land; and
a valve member received in the valve opening for movement between an open position and a closed position, the valve member including a first valve member land and a second valve member land, the first valve member land and the valve body land cooperate to define a first metering flow passage between the first and second pressure passages and the valve body land and the second valve member land cooperate to define a second metering flow passage between the first and second pressure passages, wherein an area of the first metering flow passage is less than or greater than an area of the second metering flow passage when the valve member is in the open position.

2. The control valve assembly of claim 1, wherein the valve body includes a second valve body land and a third pressure passage; the valve member includes a third valve member land; wherein the second valve member land and the second valve body land cooperate to define a third metering flow passage between the first and third pressure passages and the second valve body land and the third valve member land cooperate to define a fourth metering flow passage between the first and third pressure passages; and wherein an area of the fourth metering flow passage is less than or greater than an area of the third metering flow passage when the valve member is in the open position.

3. The control valve assembly of claim 2, wherein the area of the first metering flow passage is less than the area of the second metering flow passage and the area of the third metering flow passage is less than the area of the fourth metering flow passage when the valve member is in the open position.

4. The control valve assembly of claim 1, further including at least one actuating device configured to move the valve member between the open and the closed positions.

5. The control valve assembly of claim 7, wherein the actuating device includes a solenoid.

6. The control valve assembly of claim 5, further including a pair of solenoids configured to move the valve member between the open and the closed positions.

7. The control valve assembly of claim 5, wherein the valve member comprises a valve spool having known magnetic properties and the solenoid, when energized, produces magnetic flux that imparts a magnetic force on the valve spool.

8. The control valve assembly of claim 1, wherein the first and second valve member lands are defined by an annular valve cavity.

9. A control valve assembly for controlling distribution of fluid pressure to a fluid pressure actuator and release of fluid pressure from the fluid pressure actuator, the control valve assembly comprising:
a valve body having a valve opening, a first pressure passage, a second pressure passage;
a valve member received in the valve opening for movement between an open position and a closed position, the valve member including an annular cavity, the annular cavity and the valve body cooperate to define a flow path between the first pressure passage and the second pressure passage, the flow path including an inlet and an outlet, wherein the area of the outlet is less than or greater than the area of the inlet when the valve member is moved to the open position; and
at least one solenoid configured to move the valve member between the open and the closed positions.

10. The control valve assembly of claim 9, wherein the valve body includes a third pressure passage and the valve member includes a second annular cavity, the second annular cavity and the valve body cooperate to define a second flow path between the first pressure passage and the third pressure passage, the second flow path including a second inlet and a second outlet, wherein the area of the second outlet is less than or greater than the area of the second inlet when the valve member is moved to the open position.

11. The control valve assembly of claim 10, wherein the area of the outlet is less than the area of the inlet and the area of the second inlet is less than the area of the second outlet when the valve member is in the open position.

12. The control valve assembly of claim 9, further including a pair of solenoids configured to move the valve member between the open and the closed positions.

13. The control valve assembly of claim 9, wherein the valve member comprises a valve spool having known magnetic properties and the solenoid, when energized, produces magnetic flux that imparts a magnetic force on the valve spool.

14. A control valve assembly for controlling distribution of fluid pressure to a fluid pressure actuator, the control valve assembly comprising:
a valve body having a valve opening, a first pressure passage, a second pressure passage, and a valve body land; and
a valve member received in the valve opening for movement between an open position and a closed position, the valve member including a first valve member land and a second valve member land, the first valve member land and the valve body land cooperate to define a first metering flow passage between the first and second pressure passages and the valve body land and the second valve member land cooperate to define a second metering flow passage between the first and second pressure passages, wherein the first and second metering flow passages are configured to impart a hydrodynamic force on the valve member during fluid flow through the valve body, which biases the valve member toward the open position or the closed position.

15. The control valve assembly of claim 14, further including at least one actuating device configured to move the valve member between the open and the closed positions.

16. The control valve assembly of claim 15, wherein the actuating device includes a solenoid.

17. The control valve assembly of claim 15, further including a pair of solenoids configured to move the valve member between the open and the closed positions.

18. The control valve assembly of claim 15, wherein the valve member comprises a valve spool having known magnetic properties and the solenoid, when energized, produces magnetic flux that imparts a magnetic force on the valve spool.

19. The control valve assembly of claim 14, wherein the first and second valve member lands are defined by an annular valve cavity.
